(19) United States
(12) Patent Application Publication
(10) Pub. No.: US 2013/0041962 A1
(43) Pub. Date: Feb. 14, 2013

(54) Information Filtering

(71) Applicants: Ye Wang, Hangzhou (CH); Zhihui Tang, Hangzhou (CH)

(72) Inventors: Ye Wang, Hangzhou (CH); Zhihui Tang, Hangzhou (CH)

(73) Assignee: Alibaba Group Holding Limited, Grand Cayman, CA (US)

(21) Appl. No.: 13/569,021

(22) Filed: Aug. 7, 2012

(30) Foreign Application Priority Data
Aug. 8, 2011 (CN) 201110225345.3

(51) Int. Cl. G06F 15/16; G06F 17/30

(52) U.S. Cl. 709/206

(57) ABSTRACT

The present disclosure introduces a method, an apparatus, and a system of filtering information. In one example embodiment, a message is received and a text is retrieved from the message. It is then determined whether a filtering container includes a sample that is similar to the retrieved text. If a determination result is positive, a new sample is created for the retrieved text and the sample is added to an attribution sample database of the filtering container and the message is not transmitted. If a determination result is negative, a new sample is created for the retrieved text and the sample is added to a new sample database of the filtering container and the message is sent. The present techniques may reduce the probability of missing filtering information, improve the successful rate of filtering information, and improve the data processing efficiency.

### CROSS REFERENCE TO RELATED PATENT APPLICATIONS

This application claims foreign priority to Chinese Patent Application No. 201110225345.3 filed on 8 Aug. 2011, entitled “Computer-implemented Information Filtering method, Information filtering Apparatus and System,” which is hereby incorporated by reference in its entirety.

### TECHNICAL FIELD

The present disclosure relates to the field of data processing technology and, more specifically, to a method, a system, and an apparatus of computer-implemented information filtering.

### BACKGROUND

Information transmission functionalities enable interactions between various users connected by a network. Some malicious users, however, send a large volume of repeated messages or similar messages (which may include some phishing website links or junk advertisements) to increase their click rates. Such scenarios, if they occur in the e-commerce or email system, will increase the load and transmission volume of such systems, thereby causing huge pressure on the storage and data processing capabilities of servers of such systems. The conventional methods to filter information are described below.

One exemplary method is rule-based information filtering method. For example, users who routinely send junk messages are added into a blacklist. If the users who are listed on the blacklist try to send repeated messages again, such repeated messages are blocked. For example, one or more keywords may be established based on certain data fields in messages. If any field of these messages include such keywords, such messages are filtered. Although the rule-based information filtering method is relatively simple, direct, fast responding, such rules also expire rapidly. The updating speed of the rule is slow while contents of the messages are continuously updated. Based on the previous rules, messages sent by changed user names or with modified contents may easily avoid being regarded as junk messages. Thus a lot of junk messages cannot be effectively filtered. The success rate of information filtering is low. For example, a user with a user name listed on the blacklist may change to a new user name. If the new user name is not on the blacklist, such user can continuously send junk messages. The low success filtering rate also causes low efficiency of data processing. In addition, the creation and updating of the rules require the participation of a lot of professionals, which is labor and cost consuming.

Another exemplary method is machine-learning based information filtering method. Some messages that are deemed as junk messages and some messages that are deemed as normal messages are manually collected at first to establish a sample database. A number of collected messages need to be collected to cover a wide range. Classification models and relevant parameters may be established for the sample database. After the classification model is established, the reference data of junk messages and non junk messages may be obtained and be used to filter information. For example, for a current message, a classification of the current message may be determined. Based on the reference data of junk messages and non-junk messages, the current message is determined to be a junk message or a non-junk message. The junk message is then filtered out.

The problem of the machine-learning based information filtering method is that it is very complicated to collect the samples, establish the classification model, and obtain the reference data and it requires continuous updating of the classification model and the reference data. If the sample database is large, for example, it may include hundreds of thousands of items causing progress of the classification model to be slow. The machine-learning may need a learning period lasting several months. Thus, a huge volume of data needs to be processed which is time consuming. In addition, the creation of the classification model needs the participation of professionals who specialize in model creation. The implementation in software also needs the participation of highly skilled programmers. This method is also labor and cost demanding as the cost is still relatively high.

In addition, the above two methods are difficult to support multiple languages. The rule-based information filtering method requires a team of operation staff that is capable of processing different languages. The machine-learning based information filtering method faces more difficulties as it needs to resolve the problems of complicated word segments and semantic analysis. Some international websites, however, widely use multiple languages.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure discloses a method, a system, and an apparatus of filtering information. The present techniques may be computer-implemented and realize automatic information filtering without human intervention, thereby reducing cost, improving the success rate of information filtering, and increasing data processing efficiency.

The present disclosure discloses a method of filtering information. A message is received and a text is retrieved from the message. It is then determined whether a filtering container includes a sample that is similar to the retrieved text. If a determination result is positive, a new sample is created for the retrieved text and added to an attribution sample database of the filtering container and the message is not transmitted. If a determination result is negative, a new sample is created for the retrieved text and added to a new sample database of the filtering container and the message is transmitted

The present disclosure discloses an apparatus of filtering information. The apparatus may include a receiving module, a retrieving module, a determination module, a first processing module, and a second processing module. The receiving module receives a message. The retrieving module retrieves a text from the message. The determination module determines whether a filtering container includes a sample that is similar to the retrieved text. If a determination result is positive, the first processing module creates a new sample for the retrieved text, adds the new sample to an attribution sample database of the filtering container, and does not transmit the message. If a determination result is negative, the second processing module creates a new sample for the retrieved text, adds the new sample to a sample database of the filtering container, and transmits the message.

The present disclosure also discloses a system of filtering information. The system may include at least one receiving party message responding module, at least one sending party message responding module, and at least one apparatus of filtering information as described above. The sending party message responding module receives a message sent by a sending party, and sends the message to the apparatus of filtering information. The apparatus then filters the message. The receiving party message responding module sends the message received from the apparatus to a receiving party.

The present techniques in the present disclosure use the text in the message as the sample and selectively adds the sample into the attribution sample database or the new sample database based on whether the text in the received message is similar to texts of existing samples in the sample databases. The present techniques also determine whether to transmit the message based on whether the text in the received message is similar to texts of samples in the sample databases to filter information. The samples in the sample databases do not necessarily require manual collection and can be automatically accumulated and updated during the process of receiving messages. As human intervention is not necessary, the cost is thus reduced.

As the samples in the sample database are continuously updated based on the continuously received messages, the samples in the sample database may adapt to the latest changes of the messages. Unlike the conventional rule-based information filtering method, where the rules may not be timely updated, and the conventional machine-learning based information filtering method, where the created model or reference data may be not timely updated, the present techniques may eliminate or reduce the possibilities of missing information need to be filtered out. The present techniques may increase the success rate of information filtering.

In addition, as the probability of missing information filtering is reduced, the repeated messages that are not worth processing are also filtered. Thus the volume of information processing is reduced and the data processing efficiency is improved.

Furthermore, the present techniques do not necessarily need the establishment of rules and the creation of machine-learning models. The present techniques are directed to analysis of the text instead of semantics in the text. Thus the present techniques may support multiple languages and can be applicable to any text of any language.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure. A person of ordinary skill in the art can obtain other figures according to the figures in the present disclosure without creative efforts.

FIG. 1 illustrates a diagram of an example system of filtering information in accordance with the present disclosure.

FIG. 2 illustrates a flowchart of an example method of filtering information in accordance with a first example embodiment of the present disclosure.

FIG. 3 illustrates a diagram of an example filtering container created in accordance with the example method illustrated in FIG. 2.

FIG. 4 illustrates a flowchart of another example method of filtering information in accordance with a second example embodiment of the present disclosure.

FIG. 5 illustrates a diagram of an example apparatus of filtering information in accordance with the present disclosure.

FIG. 6 illustrates a diagram of another example system of filtering information in accordance with the present disclosure.

FIG. 7 illustrates a diagram of another example system of filtering information in accordance with the present disclosure.

### DETAILED DESCRIPTION

The following is a detailed description of the present techniques. The described embodiments herein are examples of embodiments and should not be used to restrict the scope of the present disclosure.

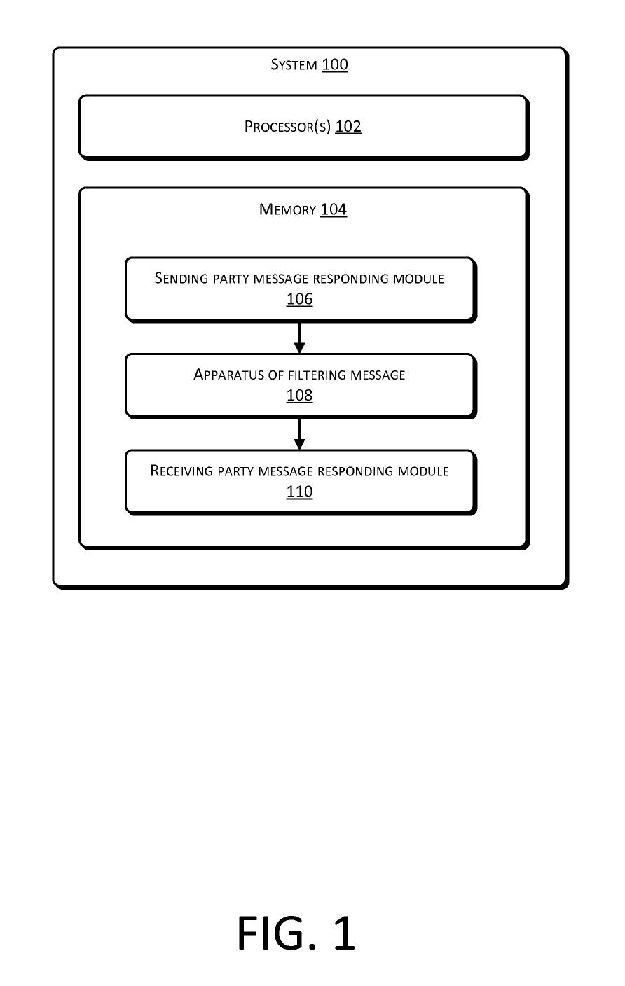

FIG. 1 illustrates a diagram of an example system 100 of filtering information in accordance with the present disclosure. The system 100 may be located between a terminal of a sending party and a terminal of a receiving party. The system 100 processes a message sent to the receiving party from the sending party. The system 100 may include, but is not limited to, one or more processors 102 and memory 104. The memory 104 may include computer storage media in the form of volatile memory, such as random-access memory (RAM) and/or non-volatile memory, such as read only memory (ROM) or flash RAM. The memory 104 is an example of computer storage media. Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include transitory media such as modulated data signals and carrier waves.

The memory 104 may store therein program units or modules and program data. In one embodiment, the modules may include a sending party message responding module 106, an apparatus of filtering message 108, and a receiving party message responding module 110.

In some examples, the sending party message responding module 106, the apparatus of filtering message 108, and the receiving party message responding module 110 may reside in different memories and executed by the same or different processors.

The sending party message responding module 106 responds to the message sent by the sending party. For example, the sending party message responding module 106 may receive the message sent by the sending party and send the message to the apparatus of filtering information 108. The receiving party message responding module 110 responds to the message to be sent to the receiving party. For example, the receiving party message responding module 110 may send the message received from the apparatus 108 to the receiving party.

The memory 104 may contain one or more of each of the sending party message responding module 106, the apparatus of filtering message 108, and the receiving party message responding module 110. The message transmitted between the sending party and the receiving party may include a sending party field, a receiving party field, and a body. The body may include a text.

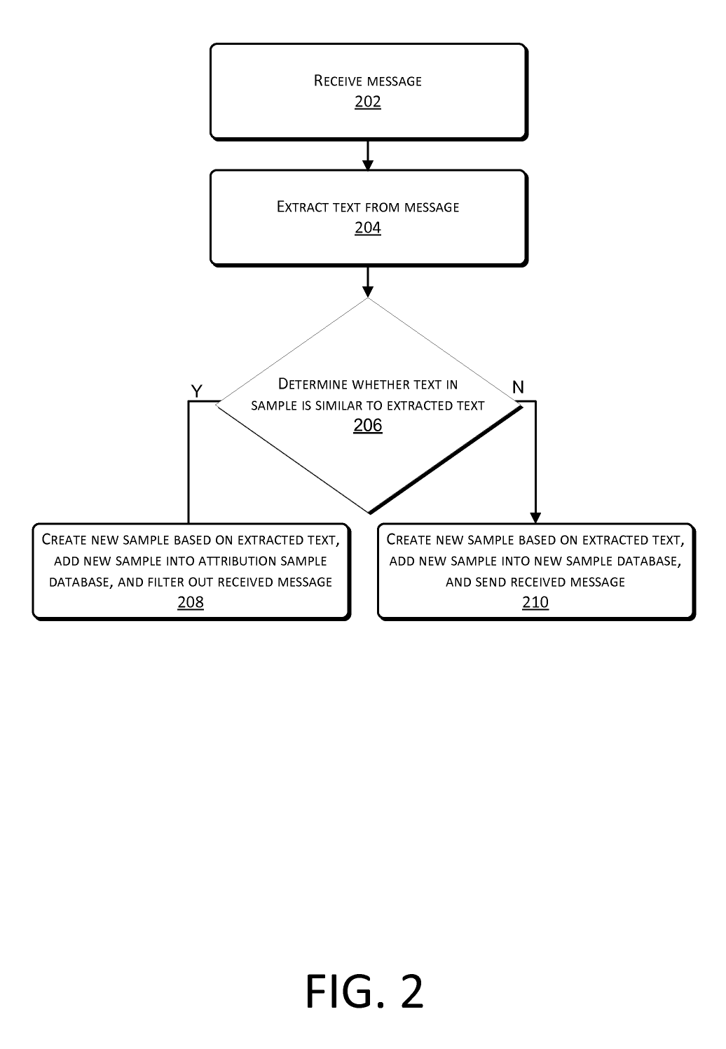

The example filtering techniques of the present disclosure are described below by reference to the system 100 as shown in FIG. 1. FIG. 2 illustrates a flowchart of an example method of filtering information in accordance with a first example embodiment of the present disclosure.

At 202, a message is received. The message may be the message received by the apparatus of filtering information 108 from the sending party message responding module 106.

At 204, a text is extracted from the message. At 206, it is determined whether a filtering container includes a sample that is similar to the retrieved text. If the filtering container includes a sample that is similar to the retrieved text, operations at 208 are performed. If the filtering container does not include a sample that is similar to the retrieved text, operations at 210 are performed.

In the example embodiments of the present disclosure, the filtering container is a set of one or more sample databases. Each sample database includes one or more similar samples. A sample may include a text and/or character information of the text such as a vector of the text, a length of the text, a classification of the text, etc. In some examples, the sample may only include the text. A text in a sample of the filtering container is a text of a previously received message, for example. If the filtering container includes a sample that is similar to the retrieved text of the currently received message, it means that a similar message was previously received. Thus, at 208, the message received at 202 may be filtered out. If the filtering container does not include a sample that is similar to the retrieved text of the currently received message, it means that no similar message was previously received. Thus, at 110, the message received at 202 may be sent.

In the example embodiments, the sample in the filtering container that includes the text similar to the retrieved text may be called a similar sample.

At 208, a new sample is created based on the text extracted from the message. The new sample is added to an attribution sample database of the filtering container and the message received at 202 is filtered out. That is, the message received at 202 is not sent. For example, the message received at 202 may be discarded and no further processing is required. In the example embodiments of the present disclosure, the attribution sample database refers to a database that stores the sample whose text is similar to the text extracted from the message at 204.

At 210, a new sample is created based on the text extracted from the message. The new sample is added to a new sample database of the filtering container and the message received at 202 is sent. At 210, the new sample database is created in the filtering container. The process to establish the new sample database may be executed after the new sample is created. Alternatively, the process to establish the new sample database may be executed concurrently when the new sample is created. Alternatively, the new sample database may be established before the new sample is created.

At 210, the apparatus of filtering message 108 sends the message received at 202 to the receiving party message responding module 110. Then the receiving party message responding module 110 sends the message to the receiving party.

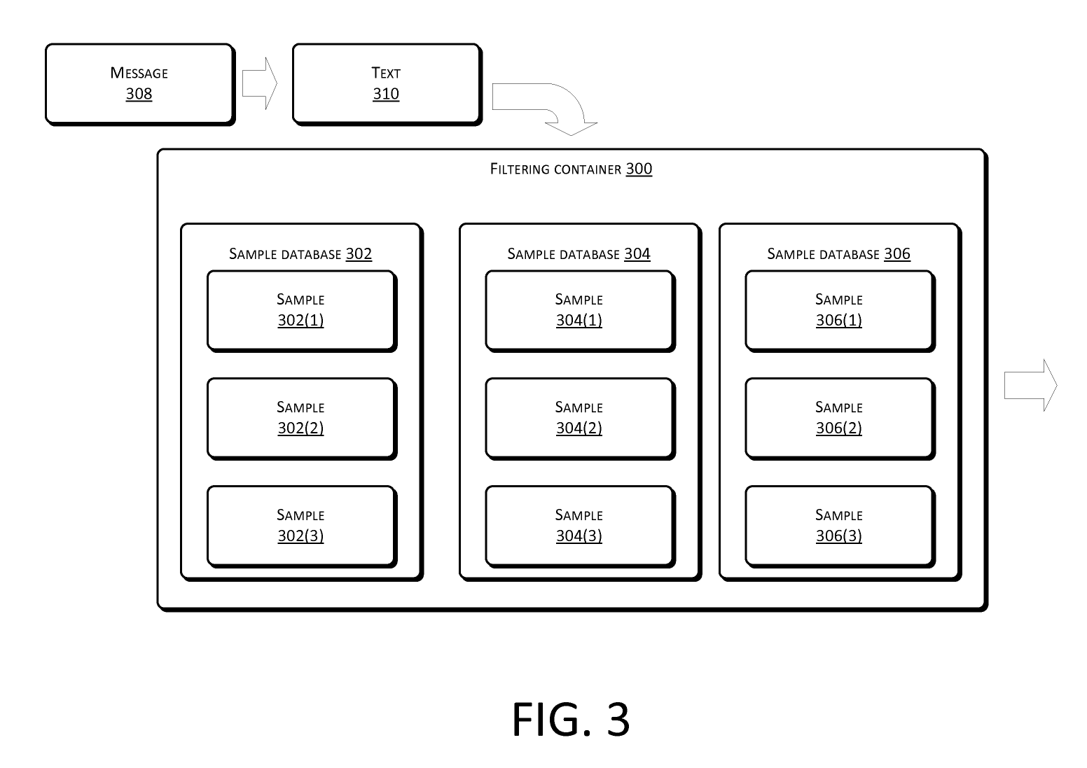

FIG. 3 illustrates a diagram of an example filtering container 300 created in accordance with the example method illustrated in FIG. 2. In the example of FIG. 3, the filtering container 300 includes three sample databases, i.e., a sample database 302, a sample database 304, a sample database 306. The sample database 302 may include a set of similar samples such as a sample 302(1), a sample 302(2), and a sample 302(3). The sample database 304 may include another set of similar samples such as a sample 304(1), a sample 304(2), and a sample 304(3). The sample database 306 may include another set of similar samples such as a sample 306(1), a sample 306(2), and a sample 306(3). In some other examples, the number of sample databases and the number of samples in each sample database may be different.

With respect to a message 308 received at 202, if a text of any sample in the filtering container 300, such as a text of the sample 304(1), is similar to a text 310 extracted from the message 308, such sample in the filtering container 300, such as the sample 304(1), is a similar sample to the message 308. At 208, a new sample is created for the text 310. The new sample is added to the sample database 304. The sample database 304 is the attribution sample database. If no text of any sample is found to be similar to the text 310 extracted from the message 308 after the filtering container 300 is searched, a new sample is created for the text 310 and a new sample database is established in the filtering container 300. The new sample is added into the new sample database.

With respect to the text in the received message, the example method in the first example embodiment of the present disclosure, based on whether the text is similar to any text of any sample in the sample database, selectively adds the sample into the attribution sample database or the new sample database and determines whether to transmit the message. The message filtering is thus realized. The samples in the sample databases do not necessarily need manual collection and can be automatically accumulated and updated during the process of receiving messages to realize automatic information filtering. As human intervention is not necessary, the cost is reduced.

As the samples in the sample databases are continuously updated based on the continuously received messages, the samples in the sample databases may adapt to the latest changes of the messages. Unlike the conventional rule-based information filtering method, where the rules may not be timely updated, and the conventional machine-learning based information filtering method, where the created model or reference data may be not timely updated, the present techniques may eliminate or reduce the possibilities of missing information need to filtered out. The present techniques may increase the success rate of information filtering.

For example, a same user may use two different user names to send a same message. Under the present techniques, even if the user names are different, a sample corresponding to the user's previously sent message may be found from the sample database of the filtering container. The repeated message is then filtered out and the scenario where the user uses multiple user names to send multiple repeated messages is avoided.

In addition, as the probability of missing information filtering is reduced, the repeated messages that are not worth processing are also filtered. Thus the volume of processed information is reduced and the data processing efficiency is improved.

Furthermore, the present techniques do not necessarily need the establishment of rules and the creation of machine-learning models. The present techniques are directed to analysis of the text instead of semantics in the text. Thus the present methods may support multiple languages and can be applicable to any text of any language.

In the example embodiments of the present disclosure, if the sample databases and samples are established before the message is received, the present techniques may determine whether there is any existing text in the sample database that is similar to the text extracted from the message. If the sample database and samples are not established, the text extracted from the message received at 202 may be used to create the new sample and the created new sample is added to a new sample database as a first sample. Subsequently received messages may be used to continuously update samples in the new sample database.

At 206, various techniques may be used to determine whether there is a sample that includes the text that is similar to the text extracted from the message. For example, one technique may be based on vectors. As another example, another technique may be based on a longest common string (LCS). As yet another example, another technique may be based on a combination of the vector and the LCS. Some of the techniques are described below.

A first example calculation technique is based on vectors. A similarity degree between two texts may be represented by a vector similarity degree. The vector similarity degree may be represented by a cosine of an angle between vectors of the two texts. At 206, a vector of the text in the message and vectors of texts of samples in the sample databases may be extracted. It is then determined whether a similarity degree between the vector of the text of the sample and the vector of the text extracted from the message is higher than or equal to a similarity degree threshold. The similarity degree threshold may be preset based on the need of data processing. A text may include one or more terms. Each term may be an English word or a Chinese character. A term frequency represents a number of times a word appears in the text. An inverse document frequency (IDF) represents a generalized importance of the term. A weight of the term may be represented by a product of the term frequency of the term and the IDF of the term. For example, a vector w of the text may be represented as: w=(w₁, w₂, . . . , wₙ), where n may be any integer and w₁, w₂, wₙ is a respective weight of a respective term in the text. After the vectors of the two texts are obtained, a cosine of angle formed by the two vectors is calculated. The higher the cosine value, the more similarity between the two texts.

In the example embodiments of the present disclosure, the vector of the text from the message and vectors of texts of samples in the sample databases may be extracted. Cosine values of various angles formed by the vector of the text from the message and the vectors of texts of samples in the sample database are calculated. The present techniques determine whether a respective cosine value is higher than or equal to the similarity degree threshold. If a respective cosine value of a respective angle formed by the vector of the text from the message and a respective vector of a text of a respective sample is higher than or equal to the similarity degree threshold, it is determined that a similarity degree between the text of the respective sample and the text extracted from the message is higher than or equal to the similarity degree threshold. That is, the filtering container includes a sample whose text is similar to the text extracted from the message.

If there is no cosine value of any angle form by the vector of the text from the message and any vector of a text of any respect sample that is higher than or equal to the similarity degree threshold after all samples in the database are traversed, it is determined that there is no similarity degree between the text of any sample and the text extracted from the message that is higher than or equal to the similarity degree threshold. That is, the filtering container does not include a sample whose text is similar to the text extracted from the message.

To more accurately calculate a similarity degree between two texts and reduce the space complexity and time complexity in calculation of the similarity degree, a local sensitive hashing (LSH) method may be used to calculate a similarity degree between a high dimension vector of the text extracted from the message and a high dimension vector of a text of a sample in the sample database. The similarity degree between the two high dimension vectors may represent the similarity degree between the two texts. In addition, the high dimension vector may represent more text characters. Before the calculation of the high dimension vectors, the text or the sample may be discretized.

A second example calculation technique is based on LCS. The LCS is a longest common string between two or more text strings. It may be a sequence of characters that are not necessarily continuous but are sequentially extracted from the text strings. LCS may represent a similarity degree between two or more text strings. For an example of two text strings, the longer the LCS, the higher the similarity degree between the two text strings. The text may be regarded as a relatively long text string.

Based on LCS, at 206, the present techniques may determine whether there is a text of any sample in the database whose LCS with the text extracted from the message is longer than or equal to a string length threshold. The string length may be a preset value.

If a respective length of LCS between a text of a respective sample and the text extracted from the message is longer than or equal to the string length threshold, it is determined that there exists a text of a sample in the sample database whose LCS with the text extracted from the message is longer than or equal to the string length threshold. That is, the filtering container includes a sample whose text is similar to the text extracted from the message. Otherwise, it is determined that a text of a sample in the sample database whose LCS with the text extracted from the message is longer than or equal to the string length threshold does not exist. That is, the filtering container does not include a sample whose text is similar to the text extracted from the message.

A third example calculation technique is based on a combination of vector and LCS. For example, a vector of the text in the message and vectors of texts of samples in the sample databases may be extracted. It is then determined whether there exists a sample whose similarity degree between the vector of its text and the vector of the text extracted from the message is higher than or equal to a similarity threshold. The selected one or more samples are regarded as first similar sample candidates. Then the present techniques determine whether there exists a second similar sample candidate from the first similar sample candidates whose LCS with the text extracted from the message is longer than or equal to a string length threshold. If there exists the second similar sample candidate, the second similar sample candidate is the similar sample that is similar to the text extracted from the message. That is, the filtering container includes a sample whose text is similar to the text extracted from the message.

Alternatively, the present techniques may firstly determine whether there are similar sample candidates based on LCS, and determine whether there exists the similar sample in the sample candidates whose similarity degree between the vector of its text and the vector of the text extracted from the message is higher than or equal to the similarity degree threshold. If there exists such a candidate, the text of the similar sample is similar to the text extracted from the message.

The third example calculation technique essentially uses double guarantee techniques to more accurately determine whether the text of the sample in the sample database is similar to the text extracted from the message, thereby providing more accurate information filtering.

In the example embodiments of the present disclosure, in order to prevent the unlimited increasing of the number of samples and sample database and to guarantee the real-time updating of the samples, the present techniques may use a least recently used (LRU) principle to dynamically eliminate some samples and/or sample databases.

At 208, the new sample is added to the similar sample's attribution sample database. The detailed operations may be as follows.

At a first operation, it is determined whether there exists one or more samples need to be deleted in the attribution sample database. If one or more samples do not need to be deleted in the attribution sample database, a second operation is performed. If one or more samples need to be deleted in the attribution sample database, a third operation is performed.

At the second operation, the new sample is added to the attribution sample database. At the third operation, the one or more samples needing to be deleted are deleted from the attribution sample database and the new sample is added to the attribution sample database.

At the first operation, the present techniques may determine whether a total number of samples in the attribution sample database will be more than a preset total sample number threshold after the new sample is added to the attribution sample database. If the total number of samples in the attribution sample database will be more than the preset total sample number threshold after the new sample is added to the attribution sample database, the present techniques determine that there exists one or more samples needing to be deleted in the attribution sample database. If the total number of samples in the attribution sample database is not more than the preset total sample number threshold after the new sample is added to the attribution sample database, the present techniques determine that there does not exist one or more samples needing to be deleted in the attribution sample database. The preset total sample number threshold may be dynamically set by a person of ordinary skill based on actual operations of message processing, which may be changed in real-time.

At the third operation, there are various methods to delete the samples. For example, a number of usage times of each sample in the attribution sample database may be obtained. The one or more samples needing to be deleted are deleted based on the usage times of the samples in the attribution sample database. For instance, a sample with a least number of usage times may be deleted. The number of usage times means a number of times that the sample is used as the similar sample. A person of ordinary skill may also use other variations to delete the samples. For instance, the samples whose number of usage times are more than a threshold can be reserved.

In the example of FIG. 3, after the text 310 is extracted from the message 308 to establish the new sample, the present techniques determine whether, after the new sample is added to the attribution sample database (such as the sample database 304 which is the sample database of the similar sample 304(1)), the total number of samples in the sample database 304 will be higher than the preset total sample number threshold. For example, the preset total sample number threshold may be set at 3. Thus, it is determined that there exists one or more samples to be deleted from the sample database 304. The number of usage times for the sample 304(1), the sample 304(2), and the sample 304(3) are obtained respectively and the sample with the least number of usage times is deleted. The new sample is then added to the sample database 304.

Through the dynamic setting of the preset total sample number threshold, one or more samples that have few number of usages times may be dynamically deleted. Thus the samples in the sample database may be dynamically updated and the volume of the sample database will not be unlimitedly increased. Thus, the message processing volume of the system of filtering message is also dynamically adjusted and effectively controlled.

At 210, the new sample database is created in the filtering container. The detailed operations may be as follows.

At a first operation, it is determined whether there exists one or more sample databases needing to be deleted in the filtering container. If there does not exist one or more sample databases needing to be deleted in the filtering container, a second operation is performed. If there exists one or more sample databases needing to be deleted in the filtering container, a third operation is performed.

At the second operation, the new sample database is created. At the third operation, the one or more sample databases needing to be deleted is deleted from the filtering container and the new sample database is created.

At the first operation, the present techniques may determine whether a total number of sample databases in the filtering container will be more than a preset total sample database number threshold after the new sample database is created in the filtering container. If the total number of sample databases in the filtering container will be more than the preset total sample database number threshold after the new sample database is created in the filtering container, the present techniques determine that there exists one or more sample databases needing to be deleted in the filtering container. If the total number of sample databases in the filtering container will not be more than the preset total sample database number threshold after the new sample database is created in the filtering container, the present techniques determine that there does not exist one or more sample databases needing to be deleted in the filtering container. The preset total sample database number threshold may be dynamically set by a person of ordinary skill based on actual operations of message processing, which may be changed in real-time.

At the third operation, there are various methods to delete the samples. For example, a total number of usage times of each sample database in the filtering container may be obtained. The one or more sample databases needing to be deleted is deleted based on the total number of usage times of the sample databases in the filtering container. For instance, a sample database with a least total number of usage times may be deleted. The total number of usage times may be a product of an average number of usage times of each sample in the sample database and a number of total samples in the sample database. A person of ordinary skill may also use other variations to delete the sample databases. For instance, the sample databases whose total numbers of usage times are more than a preset number threshold are reserved.

In the example of FIG. 3, after all the sample databases, i.e., the sample database 302, the sample database 304, the sample database 306, are traversed and the similar sample similar to the text 310 extracted from the message 308 cannot be found, the new sample is created for the text 310 and the present techniques determine whether there exists one or more sample databases to be deleted. For example, the preset total sample database number threshold may be set as 3. Thus, it is determined that there exists one or more sample databases needing to be deleted. The total number of usage times for the sample database 302, the sample database 304, and the sample database 306 are obtained respectively and the sample database with the least total number of usage times is deleted. The new sample database is then created and the new sample is added to the new sample database. If there does not exist the one or more sample databases needing to be deleted, the new sample database may be directly created in the filtering container and the new sample is added to the new sample database.

Through the dynamic setting of the preset total sample database number threshold, one or more sample databases that have fewer total number of usages times may be dynamically deleted. Thus the sample databases in the sample database may be dynamically updated and the total number of the sample databases will not be unlimitedly increased. Thus, the message processing volume of the system of filtering message is also dynamically adjusted and effectively controlled.

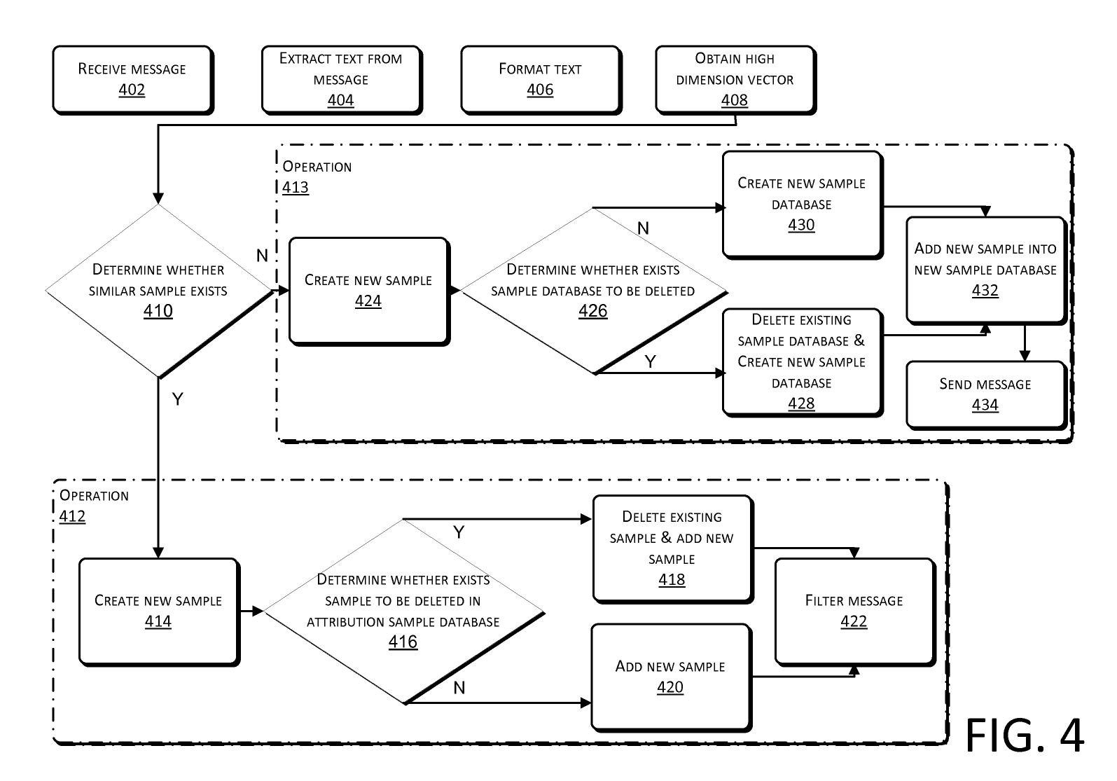

FIG. 4 illustrates a flowchart of another example method of filtering information in accordance with a second example embodiment of the present disclosure.

At 402, a message is received. At 404, a text is extracted from the message. At 406, a format operation is conducted on the extracted text. For example, one or more tags may be removed from the text that has a rich text format (RTF). As another example, escape sequences in the text may be reversed to obtain the meanings represented by the escape sequences.

At 408, the extracted text is discretized. For example, LSH method may be used to obtain the high dimension vector V1 of the text. At 410, it is determined whether the filtering container includes a sample that is similar to the text extracted from the message. For example, the present techniques may determine whether the filtering container includes a sample whose text's high dimension vector is similar to the high dimension vector V1. If there is a similar sample in the filtering container, operations at 412 are performed. If there is not a similar sample in the filtering container after all sample databases in the filtering container are traversed, operations at 413 are performed.

Operations at 412 may include the following sub-operations. At 414, a new sample is created based on the extracted text. At 416, it is determined whether there exits one or more samples needing to be deleted from the attribution sample database. For example, the present techniques may determine whether a total number of samples in the attribution sample database will be more than a preset total sample number threshold after the new sample is added to the attribution sample database. If there exists one or more samples needing to be deleted from the attribution sample database, operations at 418 are performed. If there does not exist one or more samples needing to be deleted from the attribution sample database, operations at 420 are performed.

At 418, a number of usage times of each sample in the attribution sample database is obtained. The sample that has a least number of usage times is deleted. The new sample created at 414 is added to the attribution sample database. Operations at 422 are then performed.

At 420, the new sample created at 414 is added to the attribution sample database. Operations at 422 are then performed. At 422, the message received at 402 is filtered out. That is, the message received at 402 is not sent. For example, the message may be discarded or cached at another designated device for other processing.

Operations at 413 may include the following sub-operations. At 424, a new sample is created based on the extracted text. At 426, it is determined whether there exist one or more sample databases needing to be deleted from the filtering container. For example, it is determined whether a total number of sample databases in the filtering data will be more than a preset total sample database number threshold after the new sample database is created. If there exists one or more sample databases to be deleted, operations at 428 are performed. If there does not exist one or more sample databases to be deleted, operations at 430 are performed.

At 428, a total number of usage times of each sample database in the filtering container is obtained. The one or more sample databases that have a least total number of usage times are deleted. The new sample database is created and operations at 432 are then performed.

At 430, the new sample database is created and operations at 432 are then performed. At 432, the new sample is added into the new sample database. At 434, the message received at 402 is sent.

In the second example embodiment, LSH method may be used to obtain the high dimension vector to determine whether there exists a sample whose text is similar to the text extracted from the message.

In other examples, other methods may be used. For example, at 410, after it is determined that the filtering container includes a sample whose text's high dimension vector is similar to the extracted text's high dimension vector. Such sample may be regarded as candidate similar samples. It is then further determined whether any sample in the candidate similar samples whose LCS length with the extracted text is longer than or equal to a string length threshold to determine whether there exists a similar sample in the filtering container whose text is similar to the text extracted from the message.

The above example embodiments are described by example of the sending party message responding module 106, the apparatus of filtering message 108, and the receiving party message responding module 110, where the number of each is one. In some other examples, there may be multiple sending party message responding modules and multiple receiving party message responding modules. A message processing module may be used to route the message to a corresponding receiving party message responding module after analyzing and storing the message sent by one of the multiple sending party message responding modules. The apparatus of filtering message 108 may be established between the sending party message responding module 106 and the message processing module. Alternatively, the apparatus of filtering message 108 may be established between the message processing module and the receiving party message responding module 110.

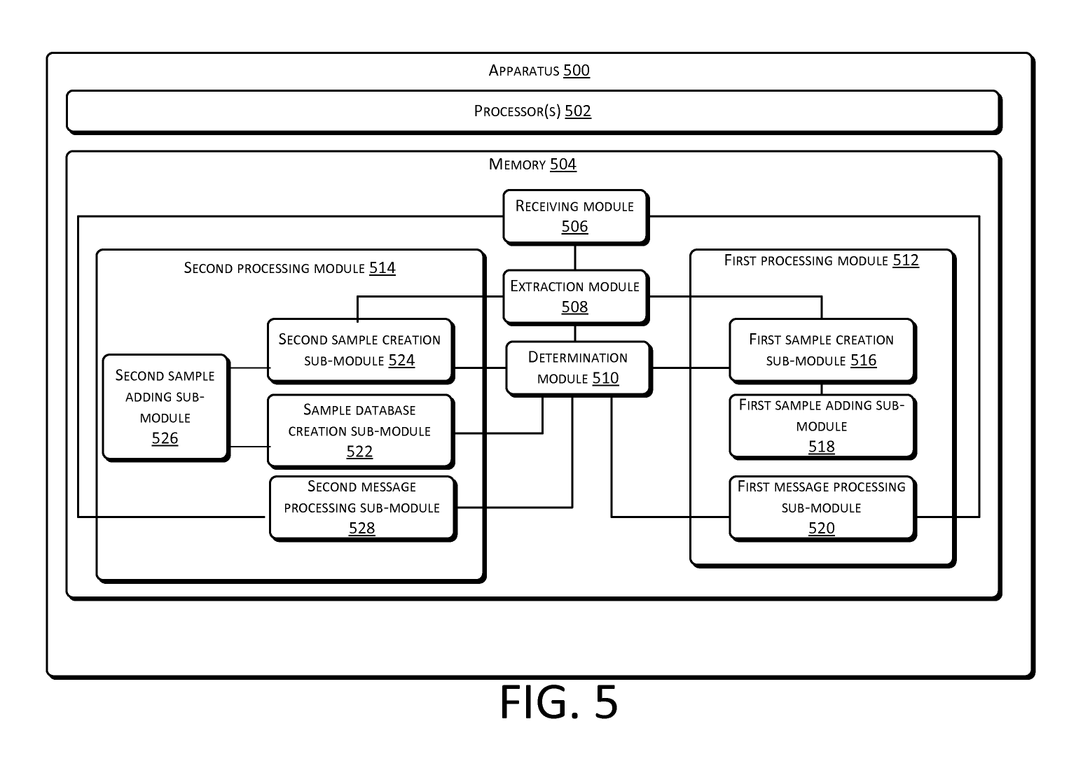

FIG. 5 illustrates a diagram of an example apparatus 500 of filtering information in accordance with the present disclosure. The apparatus 500 may include, but is not limited to, one or more processors 502 and memory 504. The memory 504 is an example of computer storage media.

The memory 504 may store therein program units or modules and program data. In one embodiment, the modules may include a receiving module 506, an extraction module 508, a determination module 510, a first processing module 512, and a second processing module 514. The receiving module 506 receives a message. The extraction module 508 is connected with the receiving module 506 to extract a text from the message received by the receiving module 506. The determination module 510 is connected with the extraction module 508 and determines whether the filtering container includes a sample whose text is similar to the extracted text from the message. The first processing module 512 is connected with the receiving module 506, the extraction module 508, and the determination module 510. After the determination module 510 determines that the filtering container includes a sample whose text is similar to the extracted text from the message, the first processing module 512 creates a new sample for the text extracted by the extraction module 508, adds the new sample into the attribution database of the filtering container, and rejects to send the message received by the receiving module 506. The second processing module 514 is connected with the receiving module 506, the extraction module 508 and the determination module 510. After the determination module 510 determines that the filtering container does not include a sample whose text is similar to the extracted text from the message, the second processing module 514 creates a new sample for the text extracted by the extraction module 508, adds the new sample into a new sample database of the filtering container, and sends the message received by the receiving module 506.

The determination module 510 may determine whether there is a sample whose text is similar to the extracted text from the message by using various methods. For example, such various methods may include the vector-based method, the LCS method, or a combination of the vector and LCS method. For example, the determination module 510 may obtain the vector of the extracted text and vectors of texts of samples stored in the sample databases of the filtering container, and determines whether the similarity degree between the vector of the extracted text and any vectors of texts of samples is higher than or equal to a similarity degree threshold. As another example, the determination module 510 may determine whether the sample databases in the filtering container includes a sample whose text's LCS length with the extracted text is longer than or equal to a string length threshold.

In the example of FIG. 5, the first processing module 512 may include a first sample creation sub-module 516, a first sample adding sub-module 518, and a first message processing sub-module 520. The first sample creation sub-module 516 is connected with the determination module 510 and the extraction module 508. After the determination module 510 determines that the filtering container includes a sample whose text is similar to the extracted text from the message, the first sample creation sub-module 516 creates the new sample for the text extracted by the extraction module 508. The first sample adding sub-module 518 is connected with the first sample creation sub-module 516, and adds the sample created by the first sample creation sub-module 516 into the attribution sample database of the filtering container. The first message processing sub-module 520 is connected with the receiving module 506 and the determination module 510. After the determination module 510 determines that the filtering container includes a sample whose text is similar to the extracted text from the message, the first message processing sub-module 520 filters out the message received by the receiving module 506. That is, the message received by the receiving module 506 will not be sent.

The first sample adding sub-module 518, when adding the sample, may determine whether there is one or more samples in the attribution sample database needing to be deleted. If there is one or more samples in the attribution sample database needing to be deleted, the first sample adding sub-module 518 deletes the samples needing to be deleted, and adds the new sample into the sample attribution database.

In the example of FIG. 5, the second processing module 514 may include a sample database creation sub-module 522, a second sample creation sub-module 524, a second sample adding sub-module 526, and a second message processing sub-module 528. The sample database creation sub-module 522 is connected with the determination module 510. After the determination module 510 determines that the filtering container does not include a sample whose text is similar to the extracted text from the message, the sample database creation sub-module 522 creates a new sample database in the filtering container. The second sample creation sub-module 524 is connected with the extraction module 508 and the determination module 510. After the determination module 510 determines that the filtering container does not include a sample whose text is similar to the extracted text from the message, the second sample creation sub-module 524 creates a new sample for the text extracted by the extraction module 508. The second sample adding sub-module 526 is connected with the sample database creation sub-module 522 and the second sample creation sub-module 524, and adds the new sample created by the second sample creation sub-module 524 into the new sample database created by the sample database creation sub-module 522. The second message processing module 528 is connected with the determination module 510 and the receiving module 506. After the determination module 510 determines that the filtering container does not include a sample whose text is similar to the extracted text from the message, the second message processing sub-module 528 sends the message received by the receiving module 506.

The sample database creation sub-module 522, when creating the new sample database, may determine whether the filtering container includes one or more sample databases needing to be deleted. If there exists one or more sample databases needing to be deleted, the sample database creation sub-module 522 deletes the one or more sample databases and then creates the new sample database.

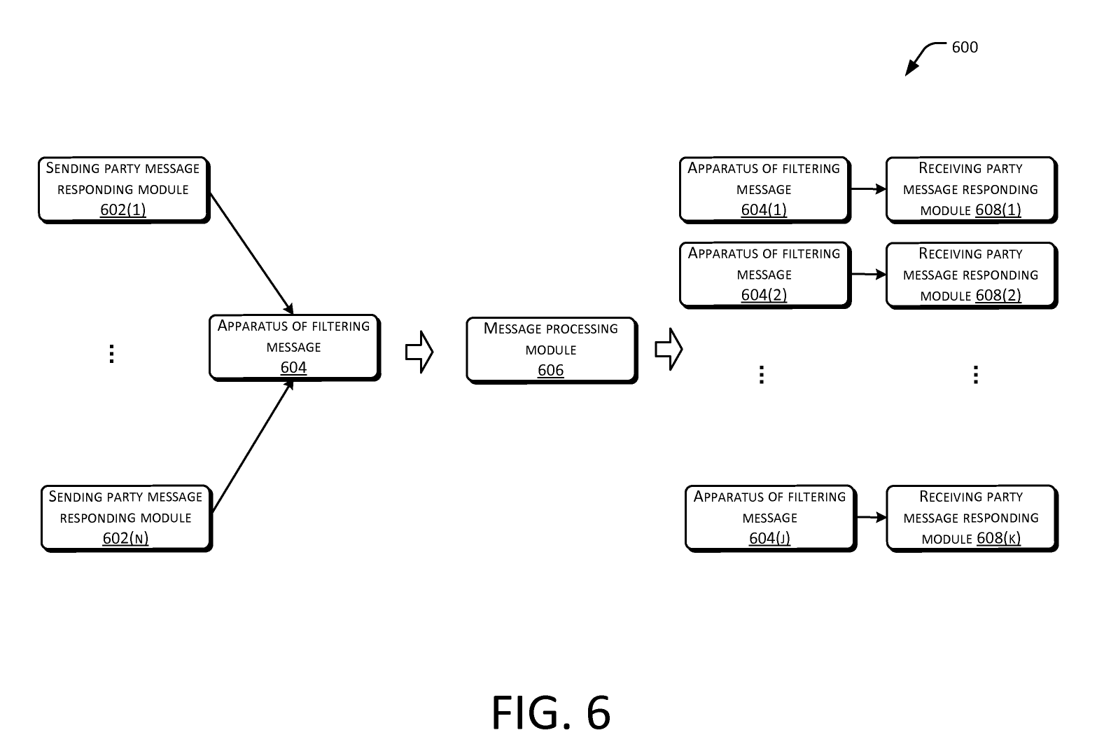

FIG. 6 illustrates a diagram of another example system 600 of filtering information in accordance with the present disclosure. The system 600 may include, but is not limited to, one or more processors and memory (both of which not shown in FIG. 6). The memory is an example of computer storage media. The memory may store therein program units or modules and program data. These modules may reside at the same or at different memory and executed by the same or different processors. The modules may include at least one sending party message responding module 602(1), . . . , 602(n), at least one apparatus of filtering information 604(1), . . . , 604(j), a message processing module 606, and at least one receiving party message responding module 608(1), . . . , 608(k), where n, j, or k can be any integer. The message processing module 606 is connected with at least one sending party message responding module 602 through at least one apparatus of filtering information 604. The message processing module 606 is also connected with at least one receiving party message responding module 608 through at least one apparatus of filtering information 604. The sending party message responding module 602 receives a message sent by a sending party, and sends the received message to the message processing module 606 for processing. For example, different sending party message responding modules 602 may be set for different sending parties. For instance, the user names may be used to differentiate different sending parties.

The receiving party message responding module 608 sends the message received from the message processing module 606 to a receiving party. For example, different receiving party message responding modules 606 may be set for different receiving parties.

The message processing module 606 analyzes the received message, and routes the received message to a corresponding receiving party message responding module 608. For example, the message processing module 606 may analyze the received message, parse a receiving party field from the message, and route the message to a corresponding receiving party based on information of the corresponding receiving party. If there are multiple receiving parties, the message processing module 606 may make multiple copies of the received message, and send them to corresponding receiving parties.

The apparatuses of filtering message 604 may be also established between the message processing module 606 and the receiving party message responding modules 608 to filter repeated messages sent to the receiving party message responding modules 608, thereby further improving the successful rate of filtering message.

As shown in FIG. 6, assuming there are n sending parties and a respective sending party message responding module 602 is set up for each of the sending party, there are n number of sending party message responding modules 602. Assuming there are k receiving parties and a respective receiving party message responding module 608 is set up for each of the receiving party, there are k number of sending party message responding modules 602. If in a certain period of time, each sending party sends m number of messages having similar texts to k receiving parties, without message filtering, there are m*n messages input into the message processing module 606. Each receiving party on average receives (m*n)/k messages. If the apparatus of filtering information 604 is used to filter messages, at an ideal situation, there will be only n messages input into the message processing module 606. Thus, the message volume is greatly reduced, the storage pressure and data processing pressure of the message processing module 606 are also reduced, and the data processing efficiency are improved.

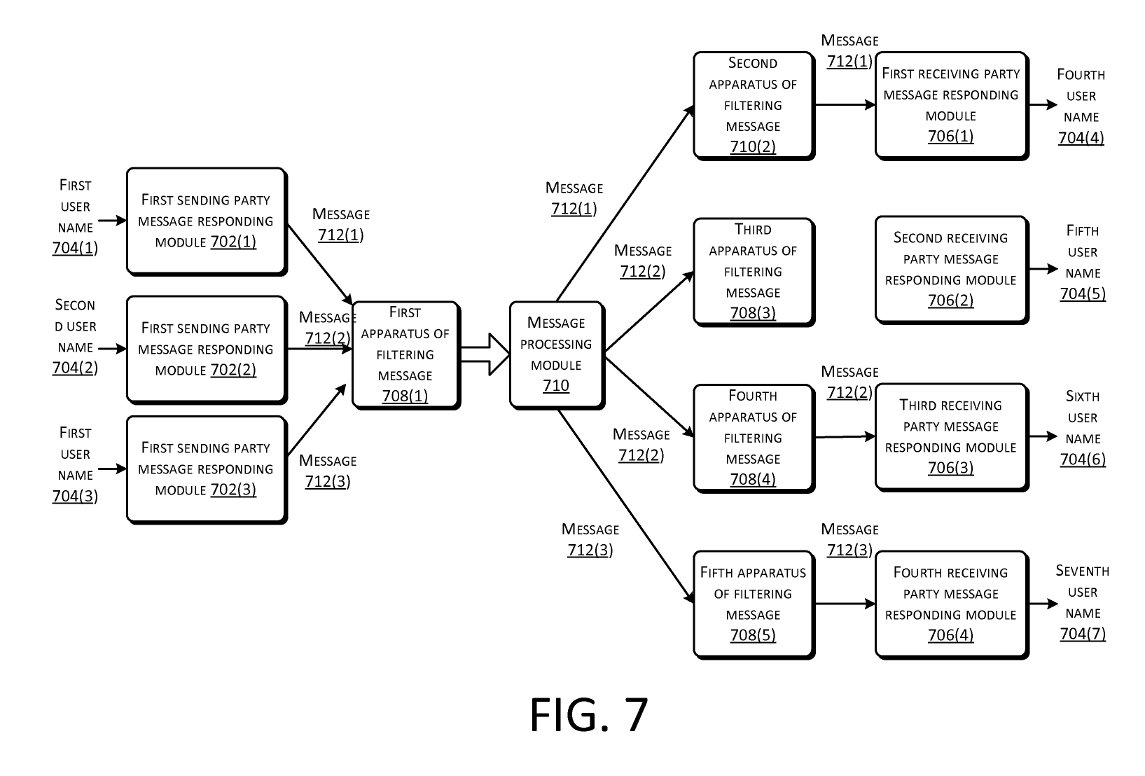

FIG. 7 illustrates a diagram of another example system 700 of filtering information in accordance with the present disclosure. The system 700 may include, but is not limited to, one or more processors and memory (both of which not shown in FIG. 7). The memory is an example of computer storage media. The memory may store therein program units or modules and program data. These modules may reside at the same or different memory and executed by the same or different processors.

The modules may include a plurality of sending party message modules 702 corresponding to a plurality of user names 704 such as a first sending party message responding module 702(1), a second sending party message responding module 702(2), and a third sending party message responding module 702(3). Such three sending party message responding modules correspond to a first user name 704(1), a second user name 704(2), and a third user name 704(3) respectively. The modules may also include a plurality of receiving party message modules 706 corresponding to a plurality of user names 708 such as a first receiving party message responding module 706(1), a second receiving party message responding module 706(2), a third sending party message responding module 706(3), and a fourth receiving party message responding module 706(4). Such four receiving party message responding modules 706 correspond to a fourth user name 704(4), a fifth user name 704(5), a sixth user name 704(6), and a seventh user name 704(7) respectively.

The system 700 may also include a plurality of apparatuses of filtering message 708. In the example of FIG. 7, a first apparatus of filtering message 708(1) is established between the plurality of sending party message responding modules 702 (such as the first sending party message responding module 702(1), the second sending party message responding module 702(2), and the third sending party message responding module 702(3)) and a message processing module 710. Between each of the plurality of receiving party message sending modules 706 and the message processing module 710, a respective apparatus of filtering message 708 may be established. In the example of FIG. 1, between each of the receiving party message responding module 706(1), 706(2) and 706(3) and the message processing module 710, a second apparatus of filtering message 708(2), a third apparatus of filtering message 708(3), a fourth apparatus of filtering message 708(4), and a fifth apparatus of filtering 708(5) is established respectively.

In one example, the plurality of the apparatuses of filtering message 708 (such as the first apparatus of filtering message 708(1), the second apparatus of filtering message 708(2), the third apparatus of filtering message 708(3), the fourth apparatus of filtering message 708(4), and the fifth apparatus of filtering 708(5)) may share a filtering container. The accumulation speed of sample databases or samples in the filtering container will be relatively fast. In a relatively short time, the number of the sample databases and the samples may reach a preset number. Some sample and/or sample databases may be deleted. That is, the elimination speed of the samples or the sample databases is also fast. With respect to repeated message received at different times, as the difference of receiving times between the two messages may be long and the elimination speed of sample or sample databases is fast, it is possible that the sample of the previous message is already deleted. Thus, the effect of filtering repeated message under this example method may be relatively weak.

In another example, each of the plurality of the apparatuses of filtering message 708 (such as the first apparatus of filtering message 708(1), the second apparatus of filtering message 708(2), the third apparatus of filtering message 708(3), the fourth apparatus of filtering message 708(4), and the fifth apparatus of filtering 708(5)) may have a separate filtering container. That is, a filtering container is set up for all sending parties, and a filtering container is set up for each of the receiving parties. The first apparatus of filtering message 708(1) may filter repeated messages sent by all sending parties and its associated filtering container is the filtering container directed to all sending parties.

Each of the second apparatus of filtering message 708(2), the third apparatus of filtering message 708(3), the fourth apparatus of filtering message 708(4), and the fifth apparatus of filtering message 708(5) filters messages sent to a respective receiving party. Their associated filtering containers are filter containers directed to a respective receiving party of the message. That is, a respective filtering container is set up for a respective receiving party user name. Thus, the number of samples and sample databases in each filtering container will not increase rapidly, and the elimination speed of samples and/or sample databases will not be too fast. The repeated messages may be effectively eliminated.

For example, the first sending party message responding module 702(1) receives a message 712(1). The message 712(1) includes a text Q1. A user name of a receiving party of the message 712(1) is the fourth user name 704(4). The second sending party message responding module 702(2) receives a message 712(2). The message 712(2) also includes a text Q1. User names of the receiving parties of the message 712(1) are the fourth user name 704(4) and the sixth user name 704(6). The third sending party message responding module 702(2) receives a message 712(3). The message 712(3) includes a text Q3. A user name of a receiving party of the message 712(3) is the seventh user name 704(7).

In theory, as the texts of the message 712(1) and 712(2) are the same, after the messages 712(1) and 712(2) are processed by the first apparatus of filtering message 708(1), only one of the messages 712(1) and 712(2) may be sent to the first apparatus of filtering message 708(1). In some cases, however, for example, the sending times of the messages 712(1) and 712(2) may be different. The filtering container of the first apparatus of filtering message 708(1) may already delete the sample created for the previously sent message. Thus the repeated messages cannot be effectively filtered and the two messages 712(1) and 712(2) having same or similar text Q1 are both sent to the message processing module 710.

If there is no apparatus of filtering message 708 set up at a side of the receiving party message responding module 706, the message processing module 710 will send the message 712(1) to the first receiving party message responding module 706(1), and send the message 712(2) to the first receiving party message responding module 706(1) and the third receiving party message responding module 706(3). Thus, the first receiving party message responding module 706(1) receives the two messages 712(1) and 712(2) that have the same text Q1.

If there is an apparatus of filtering message 708 set up at a side of the receiving party message responding module 706, the second apparatus of filtering message 710(2) may use its associated filtering container to conduct filtering processing of the two messages 712(1) and 712(2) send to the first receiving party message responding module 706(1) so that only one of the messages 712(1) and 712(2) will be sent to the first receiving party message responding module 706(1) as shown in FIG. 7. The filtering container associated with the second apparatus of filtering message 710(2) may only correspond to the first receiving party message responding module 706(1) and the increasing speed of its samples and sample databases will not be very fast, and thus its deleting speed of its samples and sample databases will also not be very fast.

Thus, to set up the apparatus of filtering message 708 at the side of the receiving party message responding module 706 to filter the repeated messages entering into the receiving party message responding module 706, increase the successful rate of message filtering, and improve the data processing efficiency. Thus, the users would not receive many repeated messages and the user experience is improved. Moreover, the situation that some malicious users send the repeated messages by registering different user names may be eliminated.

In the example of FIG. 7, the first apparatus of filtering message 708(1) is set up between the sending party message responding modules 702(1), 702(2), and 702(3), and the message processing module 710. By reference to FIG. 2, at 202, the first apparatus of filtering message 708(1) may receive all messages prior to routing. In other words, all messages sent by the sending party message responding modules 702(1), 702(2), and 702(3) are first processed by the first apparatus of filtering message 708(1). At 206, the filtering container associated with the first apparatus of filtering message 708(1) refers to a filtering container that is directed to all messages prior to router processing. That is, the same filtering container may be used for all messages sent by all sending party message responding modules 702(1), 702(2), and 702(3). After the first apparatus of filtering message 708(1) is set up between the sending party message responding modules 702(1), 702(2), and 702(3) and the message processing module 710, the message is filtered by determining whether the filtering container associated with the first apparatus of filtering message 708(1) includes a sample whose text that is similar to the text extracted from the message. For example, no matter whether the repeated messages are sent by different user names or the same user name, the message may be filtered by determining whether the filtering container associated with the first apparatus of filtering message 708(1) includes a sample whose text is similar to the text extracted from the message. Thus the situation wherein the malicious user tries to send repeated messages by changing user names may be blocked.

Each of the second apparatus of filtering message 708(2), the third apparatus of filtering message 708(3), the fourth apparatus of filtering message 708(4), and the fifth apparatus of filtering message 708(5) are set up between the message processing module 710 and the receiving party message responding modules 706(1), 706(2), 706(3), and 706(4) respectively as shown in FIG. 7. At 202, the second apparatus of filtering message 708(2), the third apparatus of filtering message 708(3), the fourth apparatus of filtering message 708(4), and the fifth apparatus of filtering message 708(5) may receive the messages after routing processing. At 206, the filtering container associated with each of the second apparatus of filtering message 708(2), the third apparatus of filtering message 708(3), the fourth apparatus of filtering message 708(4), and the fifth apparatus of filtering message 708(5) is a filtering container directed to a single receiving party's user name. That is, a filtering container is set up for different receiving party user name.

Through the setup of different apparatuses of filtering message, such as the second apparatus of filtering message 708(2), the third apparatus of filtering message 708(3), the fourth apparatus of filtering message 708(4), and the fifth apparatus of filtering message 708(5), between the message processing module 710 and the receiving party message responding modules, such as the receiving party message responding modules 706(1), 706(2), 706(3), and 706(4), a respective filtering container is set up for a respective individual receiving party user name. Thus, further processing is implemented. For example, the repeated messages may be further filtered out.

Persons skilled in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.). For example, the present message filtering techniques may be implemented by one or more processing devices with data processing capabilities such as one or more computers performing one or more computer-executable instructions. The computer storage media may store therein various computer-executable instructions to perform each operation disclosed in the present disclosure.

For example, the apparatus of filtering message in the present disclosure may be implemented by one or more processing devices executing computer-executable instructions. The modules in the apparatus of filtering message are device components with corresponding capabilities of the processing device. For instance, the receiving module may be composed of a CPU, a receiving interface, related communication lines, and computer-executable instructions with corresponding functionalities. For example, the system of filtering message in the present disclosure may be a computing system with sending and receiving message functionalities, such as an e-commerce system and an email system. The apparatus of filtering message in the system of filtering message may be the apparatus of filtering message as described above. The sending party message responding module, the receiving party message responding module, and the message processing module in the system of filtering system may be implemented by one or more system components in the computing system that execute the computer-executable instructions with corresponding message sending, message processing, and message receiving capabilities.

For example, the method of filtering message in the present disclosure may be developed by Java® programming language and the deployment circumstance may be Linux® system. Certainly the present disclosure may also use another programming language or programming system.

The method, apparatus, and system of filtering message as described in the present disclosure, use the similarity degree of texts and regional principle of repeated message and controls the similar messages that enter into the system from an entry point of the sending party and/or an entry point of the receiving party collectively or individually. The regional principle of repeated message refers to messages with same or similar texts being sent within a short period of time. After the message is sent once, it is probable that the message will be sent again in a short period of time. The present techniques may have at least following advantages:

The present techniques seamlessly support multiple languages. The processes are directed to characters and the text themselves regardless of their languages and semantics.

The present techniques have high automation. The processes do not need the participation of a lot of staff as the processing is directed to characters and the text itself instead of the semantics.

The present techniques are easy to realize and maintain. The whole structure is simple and clear. With respect to the techniques of eliminating similar texts, there may be various techniques for different application scenarios. The present disclosure only lists some example techniques. With respect to the updating of the samples and the sample databases, different techniques may be selected for different scenarios.

The present techniques provide samples that are updated and dynamically adjusted. The size of a filtering container in the present disclosure may be adjusted to realize timely expiration. The present techniques may not permit the size of the filter container to increase without limit, which may cause restriction of sending normal message. The present techniques mainly prevent malicious users from using multiple accounts and machines to frequently send repeated contents. For example, one example embodiment of the present disclosure controls the message transmission from sides of both the sending party and the receiving party.

The present techniques may effectively control the sending of many repeated messages by using multiple accounts and machines.

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be stored in other computer-readable storage which can instruct a computer or other programmable data processors to operate in a certain way, so that the instructions stored in the computer-readable storage generate a product containing the instruction device, wherein the instruction device implements the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

What is claimed is:

1. A method performed by one or more processors configured with computer-executable instructions, the method comprising:
receiving a message;
extracting a text from the message; and
determining whether a filtering container includes a sample in a sample database whose text is similar to the text extracted from the message;
wherein:
i) if the filtering container includes the sample whose text is similar to the text extracted from the message,
creating a new sample for the text extracted from the message;
adding the new sample into an attribution sample database of the filtering container; and
rejecting to send the message; and
ii) if the filtering container does not include the sample whose text is similar to the text extracted from the message,
creating the new sample for the text extracted from the message;
adding the new sample into a new sample database of the filtering container; and
sending the message.

2. The method as recited in claim 1, wherein the attribution sample database is a sample database that includes the sample whose text is similar to the text extracted from the message.

3. The method as recited in claim 1, wherein the determining comprises using a vector-based method, a longest common string (LCS) based method, or a combination of vector and LCS method to determine whether the filtering container includes the sample whose text is similar to the text extracted from the message.

4. The method as recited in claim 3, wherein the vector-based method comprises:
obtaining a vector of the text extracted from the message and a vector of the text of the sample of the filtering container; and
determining whether a similarity degree between the vector of the text extracted from the message and the vector of the text of the sample is greater than or equal to a similarity degree threshold,
if the similarity degree is greater than or equal to a similarity degree threshold, determining that the sample is a similar sample whose text is similar to the text extracted from the message; and
if the similarity degree is not greater than or equal to a similarity degree threshold, determining that the sample is not the similar sample whose text is similar to the text extracted from the message.

5. The method as recited in claim 3, wherein the LCS based method comprises:
determining whether a length of a LCS between the text extracted from the message and the text of the sample is greater than or equal to a string length threshold,
if the length of the LCS between the text extracted from the message and the text of the sample is greater than or equal to the string length threshold, determining that the sample is a similar sample whose text is similar to the text extracted from the message; and
if the length of the LCS between the text extracted from the message and the text of the sample is not greater than or equal to the string length threshold, determining that the sample is not the similar sample whose text is similar to the text extracted from the message.

6. The method as recited in claim 3, wherein the combination of vector and LCS method comprises:
obtaining a vector of the text extracted from the message and a vector of the text of the sample of the filtering container; and
determining whether a similarity degree between the vector of the text extracted from the message and the vector of the text of the sample is greater than or equal to a similarity degree threshold,
if the similarity degree is not greater than or equal to a similarity degree threshold, determining that the sample is not the similar sample whose text is similar to the text extracted from the message; and
if the similarity degree is greater than or equal to a similarity degree threshold, determining that the sample is a first similar sample candidate;
determining whether a length of a LCS between the text extracted from the message and the text of the first similar sample candidate is greater than or equal to a string length threshold,
if the length of the LCS between the text extracted from the message and the text of the first similar sample candidate is greater than or equal to the string length threshold, determining that the sample is a second similar sample candidate and determining that the sample is the similar sample; and
if the length of the LCS between the text extracted from the message and the text of the sample is not greater than or equal to the string length threshold, determining that the sample is not the second similar sample candidate and determining that the sample is not the similar sample.

7. The method as recited in claim 1, wherein the adding the new sample into the attribution sample database of the filtering container comprises:
determining whether there exists one or more samples in the attribution sample database needing to be deleted,
if there does not exist one or more samples in the attribution sample database needing to be deleted, adding the new sample into the attribution sample database; and
if there exists one or more samples in the attribution sample database needing to be deleted, adding the new sample into the attribution sample database, deleting the one or more samples from the attribution sample database and adding the new sample into the attribution sample database.

8. The method as recited in claim 7, wherein the determining whether there exists one or more samples in the attribution sample database needing to be deleted comprises:
determining whether a total number of samples in the attribution sample database is more than a preset total sample number threshold in an event that the new sample is added into the attribution sample database,
if the total number of samples in the attribution sample database is more than the preset total sample number threshold in the event that the new sample is added into the attribution sample database, determining that there exists the one or more samples in the attribution sample database needing to be deleted; and
if the total number of samples in the attribution sample database is not more than the preset total sample number threshold in the event that the new sample is added into the attribution sample database, determining that there does not exist the one or more samples in the attribution sample database needing to be deleted.

9. The method as recited in claim 8, wherein the deleting the one or more samples from the attribution sample database comprises:
obtaining a number of usage times of each sample in the attribution sample database; and
deleting the one or more samples from the attribution sample database based on the number of usage times of each sample.

10. The method as recited in claim 1, wherein the adding the new sample into the new sample database of the filtering container comprises creating the new sample database in the filtering container.

11. The method as recited in claim 10, wherein the creating the new sample database comprises:
determining whether there exists one or more sample databases in the filtering container needing to be deleted,
if there does not exist one or more sample databases in the filtering container needing to be deleted, adding the new sample database into the filtering container; and
if there exists one or more sample databases in the filtering container database needing to be deleted, deleting the one or more sample databases from the filtering container and adding the new sample database into the filtering container.

12. The method as recited in claim 11, wherein the determining whether there exists the one or more sample databases in the filtering container needing to be deleted comprises:
determining whether a total number of sample databases in the filtering container is more than a preset total sample database number threshold in an event that the new sample database is added into the filtering container,
if the total number of sample databases in the filtering container is more than the preset total sample database number threshold in an event that the new sample database is added into the filtering container, determining that there exists the one or more sample databases in the filtering container needing to be deleted; and
if the total number of sample databases in the filtering container is not more than the preset total sample database number threshold in an event that the new sample database is added into the filtering container, determining that there does not exist the one or more sample databases in the filtering container needing to be deleted.

13. The method as recited in claim 11, wherein the deleting the one or more sample databases from the filtering container comprises:
obtaining a number of usage times of each sample database in the filtering container; and
deleting the one or more sample databases from the filtering container based on the number of usage times of each sample database.

14. The method as recited in claim 1, wherein the receiving the message comprises receiving the message prior to routing processing and the filtering container is directed to the message prior to routing processing.

15. The method as recited in claim 1, wherein the receiving the message comprises receiving the message after routing processing and the filtering container is directed to a specific receiving party user name included in the message.

16. An apparatus comprising:
a receiving module that receives a message;
an extraction module that extracts a text from the message;
a determination module that determines whether a filtering container includes a sample in a sample database whose text is similar to the text extracted from the message;
a first processing module that, after the determination module determines that the filtering container includes the sample whose text is similar to the text extracted from the message, creates a new sample for the text extracted from the message, adds the new sample into an attribution sample database of the filtering container, and rejects to send the message; and
a second processing module that, after the determination module determines that the filtering container does not include the sample whose text is similar to the text extracted from the message, creates the new sample for the text extracted from the message, adds the new sample into a new sample database of the filtering container, and sends the message.

17. The apparatus as recited in claim 16, wherein the determination module further:
obtains a vector of the text extracted from the message and a vector of the text of the sample of the filtering container;
determines whether a similarity degree between the vector of the text extracted from the message and the vector of the text of the sample is greater than or equal to a similarity degree threshold, and
i) if the similarity degree is greater than or equal to a similarity degree threshold, determines that the sample is a similar sample whose text is similar to the text extracted from the message; and
ii) if the similarity degree is not greater than or equal to a similarity degree threshold, determines that the sample is not the similar sample whose text is similar to the text extracted from the message.

18. A system comprising:
at least one receiving party message responding module that receives a message sent by a sending party and sends the message to a respective apparatus of filtering message;
at least one sending party message responding module that sends the message received from another respective apparatus of filtering message that is not filtered out to a receiving party; and
at least one apparatus, the respective apparatus comprising:
a receiving module that receives the message from the at least one receiving party message responding module;
an extraction module that extracts a text from the message;
a determination module that determines whether a filtering container includes a sample in a sample database whose text is similar to the text extracted from the message;
a first processing module that, after the determination module determines that the filtering container includes the sample whose text is similar to the text extracted from the message, creates a new sample for the text extracted from the message, adds the new sample into an attribution sample database of the filtering container, and rejects to send the message; and
a second processing module that, after the determination module determines that the filtering container does not include the sample whose text is similar to the text extracted from the message, creates the new sample for the text extracted from the message, adds the new sample into a new sample database of the filtering container, and sends the message to the at least one receiving party message responding module.

19. The system as recited in claim 18, wherein the system further includes a message processing module that is connected with the at least one sending party message responding module through one of the at least one apparatus of filtering message, and is connected with the at least one receiving party message responding module through another one of the at least one apparatus of filtering message.

20. The system as recited in claim 18, wherein all sending party message responding modules are connected with the respective apparatus of filtering message, and each respective receiving party message responding module is individually connected with a corresponding apparatus of filtering message.
